(19) United States
(12) Patent Application Publication
(10) Pub. No.: US 2003/0187149 A1
(43) Pub. Date: Oct. 2, 2003

(54) Biodegradable polymer blend

(75) Inventors: Harald Schmidt, Emmerich (DE); Wolfgang Friedek, Bedburg-Hau (DE); Petra Vogt, Rees (DE)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: Bio-Tec Biologische Naturver-Packungen GMBH & Co. KG

(21) Appl. No.: 10/365,578

(22) Filed: Feb. 11, 2003

Related U.S. Application Data
(63) Continuation of application No. PCT/IB01/01407, filed on Aug. 7, 2001.

(30) Foreign Application Priority Data
Aug. 11, 2000 (CH) 1568/00
Sep. 7, 2000 (CH) 1747/00

(51) Int. Cl. C08G 63/91

(52) U.S. Cl. 525/418

(57) ABSTRACT

A biodegradable polymeric blend is provided, which can be produced by extrusion and contains at least one partly aromatic polyester, as well as aromatic and aliphatic blocks. At least 10% w. of this polymeric blend with the partly aromatic polyester contains one aliphatic polyester based on at least one hydroxycarboxylic acid and/or at least one lactone, the glass transition temperature (TG) of the aliphatic polyester being of at least 50°. This polymeric blend advantageously includes no plastifying agent and, moreover, comprises regenerating materials.

### CROSS-REFERENCE TO RELATED APPLICATIONS

This application claims priority to International Application No. PCT/IB01/01407, filed Aug. 7, 2001 which claims priority to Swiss Application Nos. 1568/00, filed Aug. 11, 2000 and 1747/00, filed Sep. 7, 2000, which applications are incorporated herein by specific reference.

### THE FIELD OF THE INVENTION

This invention relates to a biodegradable polymer blend, preferably based on regenerative raw materials, a process for producing a biodegradable polymer blend, as well as to realms of application of polymer blends, according to the invention.

### BACKGROUND AND DETAILED DESCRIPTION OF THE PREFERRED EMBODIMENTS

Biodegradable polymers, especially those based on regenerative raw materials, increasingly enter domains reserved for synthetic polymers, or so-called plastic materials. This is due to the fact that the properties of these polymers are continuously being improved. Reference is made to a large number of patent documents which deal with polymer mixtures and/or polymer blends, based on polysaccharides, such as starch, cellulose, PVA, etc. Among others, the following patent documents should be mentioned: DE 42 37 535, EP 409 781, EP 409 782, EP 495 950, EP 542 155, EP 575 349, EP 596 437, EP 799 335, WO96/31561 and WO98/0675.

In these documents, polymeric materials are described which, among other things, are based on starch. According to the latter, starch, with the aid of low molecular softeners and plasiticizers, such as glycerin, sorbitol and other additives, is brought to a very large extent into a crystalline-free fonn in order that it can be processed thermoplastically without difficulty. In addition, a number of other polymers are described as mixing partners in order to obtain improved characteristics. The additional polymers, such as, for example, chemically modified cellulose, aliphatic polyesters, polymeramides, etc., are at least partly biodegradable and partially based on regenerative raw materials.

A great disadvantage of all of these suggested polymer mixtures, based, for example, on starch, is the fact that they contain softeners, plasticizers and other low-molecular additives that can migrate from films, shaped bodies, etc., made of said material, and thus are unsuitable for a number of applications, particularly for use as material that comes in contact with foodstuffs.

In other words, the question raised for solution is to provide a polymer mixture that is biodegradable, for example, according to DIN 54900, and is based, if possible, on regenerative raw materials, and that can be used in contact with foodstuffs, i.e., a polymer mixture that complies with the regulations of EU-guidelines 82/711 and 90/128 EWG.

Thus, it is the task of one embodiment of the present invention to suggest a polymer mixture or a polymer blend that is biodegradable and based, if possible, on regenerative raw materials, and which is to a very large extent free from plasticizers or free from low-molecular compounds that can migrate from shaped bodies and films, made of the mentioned polymer mixture.

According to one embodiment of the invention, the task is solved by way of a polymer blend, obtainable by way of extrusion, which comprises at least one partially aromatic polyester component, based on aliphatic and aromatic blocks, as well as at least 10 percent by weight, related to the mixture with the partially aromatic polyester of an aliphatic polyester, based at least on lactic acid or derivatives of lactic acid and/or on one or several lactones, such as, for example, polycaprolactone, and/or on hydroxybutyric acid, hydroxyvalerianic acid and or derivatives or mixtures thereof, with a glass transition point of (TG) the aliphatic polyester of higher than 50° C.

The invented polymer blend, which can be obtained by means of extrusion, has at least one copolyester with aliphatic and aromatic blocks, or a so-called partially aromatic copolyester, as well as at least 10% of an aliphatic polyester, based on one or several hydroxycarboxylic acids, and/or based on lactones with a glass transition point (TG) of at least 50° C.

In one embodiment of the present invention the polymer blend contains no low-molecular softeners, plasticizers, or other low-molecular compounds that can migrate from films or shaped bodies, made of polymer blend.

A number of polymers or polymer mixtures that suggest similar chemical structures are known from the state of the art. Polymer mixtures, comprised of aliphatic and aliphatic/aromatic polyesters are suggested in EP 0 909 789. However, they are not obtainable by means of extrusion but by reacting a mixture of the aforementioned components. Partially aromatic polyesters, based in part on aliphatic hydroxycarboxylic acids, such as, for example, lactic acid, are suggested similarly in DE 198 48 505. Yet again, the polymers or polymer mixtures, produced in such a way, are not blends that can be obtained by means of extrusion. The same applies to DE 44 40 837 where, in a reaction apparatus, polyetherester is mixed with high-molecular hydroxycarboxylic acids, such as polycaprolactone.

Finally, thermoplastic masses are known from DE 23 31 826, which contain copolyester with aliphatic and aromatic block units, as well as linear aliphatic polyester resins, which, however, are not biodegradable. The thermoplastic masses, according to DE 23 31 826, have special electromechanical properties and contain partially flame-retarding additives, which characteristics usually preclude a biological degradability. In contrast to this, the polymer mixtures, as suggested by the invention, are obtainable by means of extrusion or by means of compounding and not primarily by chemically reacting the polymer components among one another.

Polylactides, i.e., polymers based on lactic acid or derivatives of lactic acid, are particularly suitable as polyester, based on hydroxycarbocylic acids. Linear polylactides are used most frequently. However, it is possible to use branched lactic acid polymers, in which case, for example, multifunctional acids or alcohols can serve as branching medium. It is possible to use, for example, polylactides that can be obtained primarily from lactic acid or its C₁- to C₄-alkylester, or mixtures thereof, as well as possibly from at least one aliphatic C₄- to C₁₀-dicarboxylic acid and at least one C₃- to C₁₀-alkanol with three to five hydroxy groups.

However, one can also use as aliphatic polyester those that are based on lactones, such as, for example, polycaprolactone or polymers based on hydroxy- butyric acid and/or derivatives or mixtures thereof. Specially suitable are polyhydroxybutyric acid and polyhydroxybutyric acid/valerianic acid copolyester. An increased steam-barrier characteristic can be achieved in the polymer blend, according to the invention, by adding polyhydroxybutyric acid or polyhydroxy- butyric acid/valerianic acid copolyester (PHBV). A reduced addition of polylactide, or the omission of polylactides, will result in an increased temperature stability of shaped bodies or films, made of partially aromatic polyester and PHBV at 100° C. or more.

According to another variant, it is possible to admix, in addition, native starch to the partially aromatic polyester and the aliphatic polyester, based on hydroxy-carboxylic acid (s) and/or lactone(s). In doing so, films or shaped bodies with antistatic properties can be obtained. This fact may be of significance especially for applications in the domain of electronics or in the electrical sector.

The polymer blend contains as a mixing component for the mentioned aliphatic polyester, based on hydroxycarboxylic acids and/or lactones, at least one partially aromatic copolyester, based on aliphatic and aromatic blocks. The copolyester, used according to the invention, is prepared, in addition to polyols, from aromatic or aliphatic dicarboxylic acids. As main components, the bio-degradable copolyester contains acidic components obtained from at least one aliphatic and/or one cycloaliphatic dicarboxylic acid or the ester-forming derivatives or mixtures thereof, and/or at least one aromatic dicarboxylic acid, or the ester-forming derivatives or mixtures thereof. As a diol component, the copolyester can contain at least one C₂-C₁₂-alkanediol and/or at least one C₅- to C₁₀-cycloalkanediol, or mixtures thereof, or possibly one or several components, such as ether-functions-containing hydroxy compounds.

According to a variant of the embodiment, the copolyester can be obtained through polycondensation of, on the one hand, at least one diol, for example, from the series 2,1-ethanediol, 1,3-propanediol, 1,4-butanediol and/or 1,6-hexanediol with, on the other hand, at least one aromatic dicarboxylic acid, such as, for example, terephthalic acid and possibly at least one aliphatic dicarboxylic acid, such as adipic acid and/or sebacic acid.

In principle, however, it is possible to use the carboxylic acids with a large number of carbon atoms in order to prepare the copolyester according to the invention, as for example, with up to 30 carbon atoms. Particularly the Di-C₁ to C₆-alkyl esters, such as dimethyl ester, diethyl ester, di-n-propyl ester, di-isopropyl ester, di-n-butyl ester, etc., should be mentioned as ester-forming derivatives of the aforementioned aliphatic or cycloaliphatic dicarboxylic acids, which can be used as well. Anhydrides of the dicarboxylic acids can also be used. In doing so, the dicarboxylic acids, or the ester-forming derivatives thereof, can be used individually or as mixtures of two or more thereof. Preferably, to be useful, aromatic dicarboxylic acids are generally those with 8-12 carbon atoms, and most preferably those with 8 carbon atoms. Terephthalic acid, isophthalic acid, 2,6-naphthoic acid and 1,5-naphthoic acid, as well as ester-forming derivatives thereof are to be mentioned as examples. Anhydrides of the dicarboxylic acids are also suitable ester-forming derivatives. However, aromatic dicarboxylic acids with a large number of carbon atoms, for example, up to 20 carbon atoms, can be used as well. The aromatic dicarboxylic acids, as well as the aliphatic and/or cycloaliphatic dicarboxylic acids and/or the ester-forming derivatives thereof can be used individually or as mixtures of two or more thereof. Branched or linear alkanediols with 2 to 12 carbon atoms, preferably with 4 to 6 carbon atoms, or cycloalkanediols with 5 to 10 carbon atoms, are given preference as diols. Ethylene glycol, 1,2-propanediol, 1,3-propanediol, 1,2-butanediol, 1,4-butanediol, 1,5-pentanediol, 2,2-dimethyl-1,3-propanediol, cyclopentanediol, 1,4-cyclohexaiiediolmethanol, etc., are just a few examples of suitable alkanediols. In addition, other components, as for example, dihydroxy compounds, diethylene glycol or polyethylene glycol, can be used for the preparation of the copolyester, according to the invention.

Generally, it can be said, that the above-listed copolyesters are only examples that can be supplemented by other possible, partially aromatic copolyesters. Reference is made in this connection to DE 198 49 448, in which such copolyesters that are suitable for the preparation of the invented polymer blend, are described.

To prepare the polymer blends according to one embodiment of the present invention, at least the partially aromatic copolyester, obtained from aliphatic and aromatic polyesters, together with the aliphatic polyester, based on hydroxycarboxylic acids and/or lactones, have to be mixed in an extruder, as for example, in a two-shaft extruder that runs in the same direction, and at a temperature range of approximately 120°-220° C. The temperature control depends on the base materials used and especially on the specific melting points of the substances used. Degasification, which is customary in extruders, occurs along the extruder, so that particularly when extruding, the water content is at all events <1 percent by weight, in order to prevent foaming or the development of bubbles in the extruder. The extruded material will then be cooled, customarily guided through a water bath and conditioned.

Films, as for example, packaging films for the foodstuffs sector, can now be produced from the polymer blends, as suggested by the invention. It is possible to produce transparent films, especially when using an increased polylactide content of at least 20%. When increasing the content of partially aromatic copolyesters, the flexibility of the film will increase similarly to films made of low-density polyethylenes (LDPE). If, on the other hand, a lower content of aromatic polyesters of a magnitude of about 50% is used, stiff films similar to those made of high-density polyethylene (HDPE) will result.

Naturally, the polymer blend, as suggested according to the invention, can be use not only for films but also for applications in the injection-molding sector, for coatings, etc. The great advantage of the polymer blends, according to the invention, is that it concerns so-called compounds free from plasticizers that are suitable especially for contact with foodstuffs, i.e., for food packaging.

Furthermore, the latter are biodegradable, for example, according to DIN d V 54900, which means they are compostable.

They are made in whole or in part based on regenerative raw materials.

They can be provided with antistatic characteristics by using appropriate additivies, as for example, native starch of 20%, preferably of about 25% to 30%. For such application it is necessary that the starch is native when preparing the polymer blend, according to the invention, and that the starch maintains the native corn structure to a very large extent in the preparation. In other words, the starch should to the greatest possible extent be crystalline in form in the produced polymer blend. The polymer blends, produced in this way, according to the invention, are particularly suited for applications in the electronics domain and in the electrical sector, where the respective material used must be antistatic.

This is possible particularly if in the preparation of the polymer blend according to the invention, the dosed, native starch used was pre-dried and has a residual moisture of less than about 4 to 8% of water. A breakdown of the structure of the pre-dried starch is also precluded under optimized conditions, such as a longer period of dwell and helical geometry. Thus, the starch is present in the polymer blend to a very large extent in crystalline form, as required.

For other examples of polymer blends to be prepared according to the invention, it can be advantageous, of course, if the native starch becomes completely structureless in compounding and thus is film-forming. Reference is made in this connection to Example 30, as set out further in the text.

By using at least 10, preferably at least 20% of a polylactide, it is possible to produce opaque to highly transparent films. It is also possible to color them, as desired. Although films can be produced with a feel similar to paper and/or with crinkling characteristics similar to paper, they are, nevertheless, grease-resistant and can be embossed and/or printed on, which is advantageous particularly when used in the foodstuffs sector.

Finally, it is possible to produce shaped bodies and/or moldings by means of dishing.

Realms of application of the polymer blend according to the invention are found particularly in its use as flexible packaging in the food and non-food sector. Its use is primarily intended as so-called fast-food packaging which, on the one hand, must have a good resistance to grease and, on the other hand, should be compostable. In addition, the fact that the fast-food packaging material, prepared according to the invention, is produced in whole or in part on the basis of regenerative raw materials is, of course, advantageous.

Additional realms of application are the following:

antistatic packaging for electronic articles,

dished lids for drinking cups

straws

dishable film for the coating of food packaging such as, for example, packaging (egg cartons) made of starch or foamed cellulose,

gardening supplies (plant pots, seedling trays, etc.),

support material for the cultivation of microorganisms,

hygienic films,

wrapping paper for foodstuffs,

for use as blown or plain film and for use in injection molding.

One aspect of the polymer blends according to one embodiment of the invention are the migration values which comply with the requirements of the EU guidelines. It is possible, according to this invention, to produce for the first time plasticizer-free compounds in order to make available suitable materials especially for the food and/or fast-food sector. Global migration values of blends, based, for example, on thermoplastic or structureless starch, are, due to the migration of the plasticizers contained therein, substantially above the values that have now been reached with the polymer blends according to the invention and are, therefore, mostly above the limit set for the use of materials that come into contact with foodstuffs. By using the polymer blends, as suggested according to the invention, the harmlessness of the migratory substances from a health point of view can be taken into consideration, since the total migration is far below the stipulated limits.

In addition, there are advantages to the use of the product in the fast-food sector due to characteristics such as dishability or the ability to crumple. The fact that this product is less pervious to steam than it has been possible to achieve up to now with starch blends known in the state of the art is helpful for this realm of application. The steam permeability can be decisively lowered especially on account of the increased content of polyhydroxybutyric acid or the polyhydroxy- butyric acid/valerianic acid copolymer.

Additional, technical characteristics, as for example, the good antistatic properties or the use as stretch-shrink film, result in further application possibilities, particularly in the non-food sector. The stretchability of films, made of polymer blends according to the invention, in which a stretching ratio of up to 1:6 and more is definitely possible, should also be pointed out in this respect. It is, of course, possible to admix to the polymer blend, according to one embodiment of the invention, other polymers, particularly and preferably biodegradable polymers, as for example, cellulose derivatives, such as cellulose esters, fatty acid derivatives, polyesteramides, etc. Furthermore it is possible to admix to the polymer blend organic as well as inorganic fillers and pigments, provided they are appropriate for the respective purpose. Thus, it is possible to add, for example, talcum, kaolin or titanium dioxide.

### EXAMPLES

The invention is further explained below by way of examples and by referring to the added examples of formulation:

1. Example of a formulation for the preparation of a polymer blend for the production of highly transparent films:

Ecoflex SBX 7000 (BASF): 70%

Ecopla 6200 (Cargill Dow Polymers) 30%

A migration test at 70° C. for 30 minutes complies with the fast-food requirements (the migration limit, according to EU guidelines, is 10 mg/dm² or 60 milligrams per kilogram of food).

2. Polymer blend for the production of a film with a good steam barrier:

Ecoflex SBX 7000 (BASF): 56%

Ecopla 6200 D (Cargill Dow Polymers): 24%, and

Polyhydroxybutyric acid/valerianic acid copolymer: 20%

Steam permeability (WVTR)<4 g/m² and day-measured at 23° C. and 60% relative humidity, and temperature stability of 70°-80° C. can be increased to above 100° C. without the addition of Ecopla.

3. Polymer blend for the production of films or shaped bodies with anstistatic properties:

Ecoflex SBX 7000 (BASF): 63%

Ecopla 6200 D (Cargill Dow Polymers): 10%

27% of corn starch (32% added as native starch with 12% naturally bound water)

Water: 17%.

Additional examples can be ascertained from the following tables:

| | Example | | | | | |
|---|---|---|---|---|---|---|
| | 4 | 5 | 6 | 7 | 8 | 9 |
| | Intern. No. | | | | | |
| | 1023 | 9430 | 9411, 9433 | 9412 | 9413 | 9414 |
| Formulation [%] | | | | | | |
| Starch | 27 (TS) | | | | | |
| Sorbitol | | | | | | |
| Glycerin | | | | | | |
| TPS | | | | | | |
| PLA | 10 | 9.80 | 29.8 | 49.8 | | |
| Polyesteramide | | | | | | |
| Polyester 1 | 63 | 89.8 | 69.8 | 49.8 | 89.8 | 69.8 |
| Polyester 2 | | | | | | |
| PCL | | | | | 9.8 | 29.8 |
| PHB/PHBV | | | | | | |
| PET | | | | | | |
| Inorganic filler | | | | | | |
| Slipping agent | 0.4 B | 0.4 B | 0.4 B | 0.4 B | 0.4 B | 0.4 B |
| H₂O | | | | | | |
| Compounding | | | | | | |
| T [° C.] | | | 180 | 180 | | |
| MFI [g/10 | 7.26 | 6.48 | 7.7 | 19.1 | 5.41 | 4.68 |
| min] | | (2.16) | (2.16 kg) | (2.16 kg) | | |
| 190° C., 5 kg | | | | | | |
| Granulate | 0.13 | 0.09 | 0.31 | | 0.26 | 0.25 |
| Gra H₂O [%] | | | | | | |
| Application | | | | | | |
| Blown film | X | X | X | X | | |
| Plain film | X | X | X | | | |
| Plates | X | | | | | |
| Injection | | | X | X | | |
| molding | | | | | | |
| Fibres | | | | | | |
| Characteristics of the film | | | | | | |
| Thickness of | 39 | 25 | 33 | | | |
| film | | | | | | |
| [μm] | | | | | | |
| Tensile | 27.0/31.4 | 33.5/51.8 | 34.0/30.9 | | | |
| strength | | | | | | |
| IGS/transverse | | | | | | |
| [N/mm²] | | | | | | |
| Stretch | 468/622 | 851/743 | 398/369 | | | |
| Lengthwise/ | | | | | | |
| Crosswise [%] | | | | | | |
| WVTR [gm⁻²d⁻¹] | | 82.4 | 78.0 | | | |
| Thickness of | | 22-29 | 28-31 | | | |
| film | | | | | | |
| [μm] | | | | | | |
| Migration | | | | | | |
| Values | | | | | | |
| Contact time | | | 30 min, | | | |
| | | | 70° C./5 d, | | | |
| | | | 40° C. | | | |
| Acetic acid | | | 0.8/2.6 | | | |
| Isooctane | | | 6.2/5.0 | | | |

| | Example | | | | |
|---|---|---|---|---|---|
| | 10 | 11 | 12 | 13 | 14 |
| | Intern. No. | | | | |
| | 9415 | 9411 + 9419 | 9432 | 9436 | 9437 |
| Formulation [%] | | | | | |
| Starch | | | | | |
| Sorbitol | | | | | |
| Glycerin | | | | | |
| TPS | | | | | |
| PLA | | 23.9 | 19.8 | 9.6 | 36.6 |
| Polyesteramide | | | | | |
| Polyester 1 | 49.8 | 55.9 | 79.8 | 89.6 | 59.6 |
| Polyester 2 | | | | | |
| PCL | 49.8 | | | | |
| PHB/PHBV | | 19.9 | | | |
| PET | | | | | |
| Inorganic filler | | | | | |
| Slipping agent | 0.4 B | 0.3 B | 0.4 B | 0.8 B | 0.8 B |
| H₂O | | | | | |
| Compounding | | | | | |
| T [° C.] | | | | 180 | |
| MFI [g/10 min] | 4.08 | | 7.15 | 8.3 | 9.02 |
| 190° C., 5 kg | | | | | |
| Granulate | 0.24 | | 0.06 | 0.06 | 0.06 |
| Gra H₂O [%] | | | | | |
| Application | | | | | |
| Blown film | | X | | X | X |
| Plain film | | X | | X | X |
| Plates | | | | | |
| Injection Molding | | X | | X | X |
| Fibres | | | | | |
| Characteristics of the | | | | | |
| film | | | | | |
| Film thickness | | | 22 | 28 | |
| [μm] | | | | | |
| Tensile strength | | | 32/39 | 38/20 | |
| Lengthw./crosswise | | | | | |
| [N/mm²] | | | | | |
| Stretch | | | 390/630 | 324/331 | |
| Lengthw./crosswise | | | | | |
| [%] | | | | | |
| WVTR [gm⁻²d⁻] | | 40.0 | | | |
| film thickness [μm] | | 28-35 | | | |
| Migration Values | | | | | |
| Contact time | | 5 d, 40° C. | | | |
| Acetic acid | | 2.8 | | | |
| Isooctane | | 7.4 | | | |

| | Example | | | | | |
|---|---|---|---|---|---|---|
| | 15 | 16 | 17 | 18 | 19 | 20 |
| | Intern. No. | | | | | |
| | 9441 | 9448 | 9449 | 9451 | 9458 | 9459 |
| Formulation [%] | | | | | | |
| Starch | | | | | | |
| Sorbitol | | | | | | |
| Glycerin | | | | | | |
| TPS | | | | | | |
| PLA | 19.4 | 20.8 | 29.8 | 29.6 | 14.84 | 9.76 |
| Polyesteramide | | | | | | |
| Polyester 1 | 79.4 | 69.8 | 69.8 | 69.6 | 74.84 | |
| Polyester 2 | | | | | | 89.76 |
| PCL | | | | | | |
| PHB/PHBV | | | | | | |
| PET | | | | | 9.84 | |
| Inorganic filler | | 9.0 | | | | |
| Slipping agent | 1.2 B | 0.4 A | 0.4 C | 0.27 A | 0.4 8 B | 0.4 8 B |
| | | | | 0.27 B | | |
| | | | | 0.27 C | | |
| H₂O | | | | | | |
| Compounding | | | | | | |
| T [° C.] | 180 | 180 | 180 | 180 | 180 | 200 |
| MFI [g/10 | 7.95 | 7.18 | 7.34 | 8.29 | 3.08 | 3.17 |
| min] | | | | | | |
| 190° C., 2.16 | | | | | | |
| kg | | | | | | |
| Granulate | 0.05 | 0.09 | 0.08 | 0.07 | 0.08 | 0.21 |
| Gra H₂O [%] | | | | | | |
| Application | | | | | | |
| Blown film | X | X | X | X | X | X |
| Plain film | X | X | X | X | | |
| Plates | | | | | | |
| Injection | X | X | X | X | | X |
| Molding | | | | | | |
| Fibres | | | | | | |
| Characteristics of | | | | | | |
| the film | | | | | | |
| Film | | | | | | |
| thickness | | | | | | |
| [μm] | | | | | | |
| Tensile | | | | | | |
| strength | | | | | | |
| IGS/crosswise | | | | | | |
| [N/mm²] | | | | | | |
| Stretch | | | | | | |
| Lengthwise/ | | | | | | |
| Crosswise | | | | | | |
| [%] | | | | | | |
| WVTR | | | 90.5 | | | |
| [gm⁻²d⁻¹] | | | 28-34 | | | |
| film thickness | | | | | | |
| [μm] | | | | | | |
| Migration Values | | | | | | |
| Contact time | | | 5 d, | | | |
| | | | 40° C. | | | |
| Acetic acid | | | 2.1 | | | |
| Isooctane | | | 3.7 | | | |

| | Example | | | | | |
|---|---|---|---|---|---|---|
| | 21 | 22 | 23 | 24 | 25 | 26 |
| | Intern. No. | | | | | |
| | 9460 | 9461 | 9462 | 9463 | 9464 | 9469 |
| Formulation [%] | | | | | | |
| Starch | | | | | | |
| Sorbitol | | | | | | |
| Glycerin | | | | | | |
| TPS | | | | | | |
| PLA | 19.76 | 20.0 | 29.84 | 19.84 | | 30.0 |
| Polyesteramide | | | | | | |
| Polyester 1 | | | 34.84 | 69.84 | 86.8 | |
| Polyester 2 | 79.76 | 80.0 | 34.84 | | | 70.0 |
| PCL | | | | 9.84 | 12.46 | |
| PHB/PHBV | | | | | | |
| PET | | | | | | |
| Inorganic filler | | | | | | |
| Slipping | 0.48 B | | 0.48 B | 0.48 B | 0.74 | |
| Agent | | | | | | |
| H₂O | | | | | | |
| Compounding | | | | | | |
| T [° C.] | 200 | 200 | 200 | 185 | 185 | 200 |
| MFI [g/10 | 3.74 | 3.82 | 5.11 | 9.05 | 5.67 | 4.38 |
| min] | | | | | | |
| 190° C., 2.16 | | | | | | |
| kg | | | | | | |
| Granulate | 0.27 | 0.26 | 0.11 | 0.08 | 0.08 | 0.11 |
| Gra H₂O [%] | | | | | | |
| Application | | | | | | |
| Blown film | X | X | X | X | | X |
| Plain film | X | X | X | | | |
| Plates | | | | | | X |
| Injection | X | X | X | | | |
| Molding | | | | | | |
| Fibres | | | | | | |
| Characteristics of | | | | | | |
| the film | | | | | | |
| Film | | | | | | |
| thickness | | | | | | |
| [μm] | | | | | | |
| Tensile | | | | | | |
| strength | | | | | | |
| IGS/crosswise | | | | | | |
| [N/mm²] | | | | | | |
| Stretch | | | | | | |
| Lengthwise/ | | | | | | |
| Crosswise | | | | | | |
| [%] | | | | | | |
| WVTR | | | | | | 61.3 |
| [gm⁻²d⁻¹] | | | | | | 29-35 |
| film thickness | | | | | | |
| [μm] | | | | | | |
| Migration Values | | | | | | |
| Contact time | | | | | | 5 d, |
| | | | | | | 40° C. |
| Acetic acid | | | | | | 3.2 |
| Isooctane | | | | | | 3.3 |

| | Example | |
|---|---|---|
| | 27 | 28 |
| | Intern. No. | |
| | 9438 | 0142 + 0029 |
| Formulation [%] | | |
| Starch | | 15.0 |
| Sorbitol | | |
| Glycerin | | |
| TPS | | |
| PLA | 29.6 | 24.8 |
| Polyesteramide | | |
| Polyester 1 | 69.6 | 56.4 |
| Polyester 2 | | |
| PCL | | |
| PHB/PHBV | | |
| PET | | |
| Inorganic filler | | |
| Slipping agent | 0.8 B | 0.17 A |
| | | 0.37 B |
| | | 0.17 C |
| H₂O | | |
| Compounding | | |
| T [° C.] | 180 | 3.2 |
| MFI [g/10 min] | 10.25 | |
| 190° C., 5 kg | (2.16 kg) | |
| Application | | |
| Blown film | X | X |
| Plain film | | X |
| Plates | | X |
| Injection Molding | X | X |
| Fibres | | |
| Characteristics of the film | | X |
| Film thickness | 27 | |
| [μm] | | |
| Tensile strength | 42.3/40.6 | |
| Lengthw./crosswise | | |
| [N/mm²] | | |
| Stretch | 272/312 | |
| Lengthwise/ | | |
| Crosswise [%] | | |
| WVTR [gm⁻²d⁻¹ | 82.3 | |
| Thickness of film | 20-30 | |
| [μ] | | |
| Migration Values | | |
| Contact time | 5 d, | |
| | 40° C. | |
| Acetic acid | 2.6 | |
| Isooctane | 2.9 | |

Key: By starch is meant native starch, such as potato or corn starch.

Polyester 1: Terephthalic acid butanediol adipic acid copolyester (Ecoflex)

Polyester 2: Poly (butylene) succinate or poly (butylene) succinate/adipate (Biomax 6929 by DuPont)

Fillers: For example, talcum or kaolin

Residual moisture: (4) according to the extruder<1 percent by weight, and

Slipping agent: A=Erucic acid amide B=polyolester C=natural wax

Additional comments on the examples listed in the tables: Used as polylactide were, among others, Ecopla 6200 D by Cargill Dow Polymers, Lacea H 100 J, Lacea H 100 E, Lacea H 100 PL (both by Mitsui Chemicals), as well as Ecopla 3000 D by Cargill Dow Polymers.

Particularly, a comparison of examples 4-6 and that of 11 showed a marked difference in steam permeability, in that example 11, wherein 19.9% of a mixture, consisting of polyhydroxybutyric acid and polyhydroxybutyric acid/valerianic acid copolyester, shows a definitely lower steam permeability.

Furthermore, reference is made to the migration values that have been determined for some formulations and all of which, according to the guideline, are below the migration limit of 10 milligrams per dm².

### Example No. 29

55% of PLA polylactide (EcoPla 6200 D) and 44.6% of polyester I (Ecoflex sbx) with 0.4 slipping agent (Loxamid, produced by Cognis-Erucasäureamid)* [*Loxamid, produced by Cognis Erucic Acid Ainide] were compounded and granulated, in the two-shaft extruder (Werner & Pfleiderer ZSK 40), into a thermoplastic melt with a final melting point of 185° C. The polymer mixture, obtained in this way, had a MFI-(g/10 min) 190° C., 5 kg of 9.5. On a Collin film-blowing installation a transparent film in the form of a bag of 275 mm in width and a wall thickness of 0.08 mm was produced from this polymer-blend granulate. The film can be easily printed on and heat-sealed at about 110° C. This bag was used for producing beverage packaging of 275 mm×140 mm x 0.08 in size by way of heat-sealing.

The bag was filled with milk, as a sensitive beverage and liquid substance. It was then stored in the refrigerator at 8° C. and tested for storage characteristics related to the contents as well as to the packaging material.

Results: The bag remained completely sealed.

No milk odour was detected in the refrigerator after a storage time of 72 hours.

The milk itself remained odourless and unchanged in taste during the storage time.

The bag remained undamaged after being subjected to a dropping test front a height of 1 m.

After a storage time of 72 hours, the bag was unchanged in its visual and physical characteristics.

Table:

A bag, made of polymer blend, as set out in Example 29; the (wall) thickness of the film is 0.08 mm.

| | Storage | Storage | Storage | Storage | | Beginning | End of |
|---|---|---|---|---|---|---|---|
| Kind of | time, | time. | time, | time, | Weight | of pH | pH |
| milk | beginning | 1 day | 2 days | 3 days | loss | test | test |
| 1. H. | 1,038.1 g | 1,037.6 g | 1,037.2 g | 1,038.6 g | 1.2 g | 6.58 | 6.71 |
| full- | | | | | | | |
| cream | | | | | | | |
| milk | | | | | | | |
| 3.5% | | | | | | | |
| 2. H. | 1,035.0 g | 1,034.8 g | 1,034.3 g | 1,033.6 g | 1.4 g | 6.62 | 6.65 |
| milk, | | | | | | | |
| low in | | | | | | | |
| fat, | | | | | | | |
| 1.5% | | | | | | | |
| 3. H. | 1,036.1 g | 1,035.5 g | 103.3 g | 1,035.0 g | 1.1 g | — | 6.65 |
| milk, | | | | | | | |
| low in | | | | | | | |
| fat, | | | | | | | |
| 1.5% | | | | | | | |
| 4. Full- | 1,033.0 g | 1,032.5 g | 1,032.0 g | 1,031.5 g | 1.5 g | 6.72 | 6.72 |
| cream | | | | | | | |
| milk, | | | | | | | |
| 3.5% | | | | | | | |
| 5. Full- | 1,048.7 g | 1,048.3 g | 1,048.0 g | 1,047.6 g | 1.1 g | — | 6.70 |
| cream | | | | | | | |
| milk, | | | | | | | |
| 3.5% | | | | | | | |
| 6. Milk, | 1,005.3 g | 1,004.8 g | 1,004.6 g | 1,004.2 g | 1.1 g | 6.79 | 6.77 |
| low in | | | | | | | |
| fat, | | | | | | | |
| 1.5% | | | | | | | |
| 7. Full- | 1,008.9 g | 1,008.4 g | 1,008.1 g | 1,007.7 g | 1.2 g | 6.79 | 6.77 |
| cream | | | | | | | |
| milk, | | | | | | | |
| 3.5% | | | | | | | |
| 8. Full- | 1,026.5 g | 1,025.9 g | 1,025.4 g | 1,024.8 g | 1.7 g | — | 6.72 |
| cream | | | | | | | |
| milk, | | | | | | | |
| 3.5% | | | | | | | |

In another test, beverage packaging in the form of bags, produced according to Example 29 and containing orange juice, was tested. This test confirmed that the polymer blend, according to one embodiment of the invention, provides good protection for beverages, and that the material is suited for use as beverage packaging, as coating for beverage packaging and/or as inliner for liquid and semi-liquid food packaging.

Based on Example 29, it was possible to clearly show that the polymer blends, as suggested according to the embodiment of the invention, are suitable for food packaging and especially for the packaging of beverages. Thus, it is possible to produce, as suggested in Example 29, either packaging in the form of bags, made of the polymer blends according to the embodiment of the invention, or beverage packaging which is reinforced by cardboard on the outside, as mechanical protection, and which has on the inside a film skin, consisting of the polymer blend according to the invention.

However, it is possible, of course, to produce any containers by using a polymer blend according to the invention for the purpose of receiving liquid substances and/or viscous or semi-liquid substances, and especially for receiving the above-mentioned beverages and other liquid foods, as for example, cooking oil.

### Example 30

A polymer mixture, according to the invention, is composed of the following:

15% native potato starch (dry)

15% polylactide Ecopla 6200 D.(Nature Works 6200 D)

70% polyester I Ecoflex SBX 7000

0.4% slipping agent Loxiol EP 728 (Cognis)

The so-called slipping agent Loxiol EP 728 is a polyol partial ester, produced by the firm of Henkel KgaA, Düfsseldorf, COK Plastics and Coatings. Owing to its polar character, Loxiol EP 728 is specially suited to improve the flow characteristics in the injection-molding process of polyesters, among others. In addition, this leads to a better distribution of fillers and pigments in the polymer melt.

The composition was obtained by way of compounding it into a homogeneous melt in a two-shaft extruder (Werner & Pfleiderer, ZSK 40), at a melting temperature of 170° C. and with complete degassing. The granulate obtained has a MFI (g/10 min.) 190° C., 5 kg) of 13.7 and a residual moisture of 0.2%.

The granulate is suited for further processing as blown film, plain film and as injection molding. The almost transparent films obtained are free from plasticizers. They can be easily printed on and heat-sealed.

The microscopic examination of the film showed, as a complete surprise, that granular structures of the starch were no longer present. We start out from the assumption that under the optimized compounding conditions, the native potato starch, which is added together with the natural water content of approximately 18%, is completely broken down in structure and becomes film-forming.

The listed examples serve solely the purpose of providing a better explanation of this invention. The latter is not at all limited to the materials used in the examples. In one embodiment of the present invention a polymer blend contains at least one part of aromatic polyesters, based on aliphatic and aromatic blocks, as well as at least one aliphatic polyester, prepared, among other things, on the basis of hydroxycarboxylic acids and/or lactones, and/or the derivatives thereof. Depending on the content of the different substances, variable properties can be produced. However, in this connection the polymer blend is at least almost free from plasticizers and/or free from low-molecular components, which can migrate from the films or shaped bodies that are made of the polymer blends, according to the invention.

What is claimed is:

1. A biodegradable polymer blend, obtainable by way of extrusion, comprises:
at least one partially aromatic polyester component, based on aliphatic and aromatic blocks, as well as at least 10 percent by weight, related to the mixture with the partially aromatic polyester of an aliphatic polyester, based at least on lactic acid or derivatives of lactic acid and/or on one or several lactones, such as, for example, polycaprolactone, and/or on hydroxybutyric acid, hydroxyvalerianic acid and or derivatives or mixtures thereof, with a glass transition point of (TG) the aliphatic polyester of higher than 50° C.

2. A biodegradable polymer blend according to claim 1, wherein the polymer blend is obtainable by extrusion in a two-shaft extruder.

3. A polymer blend according to claim 1, further comprising a content of aliphatic polyester of at least about 15 percent by weight, related to the mixture with the partially aromatic polyester of at least about 20 percent by weight.

4. A polymer blend according to claim 1, further comprising at least one partially aromatic copolyester, based on aromatic or aliphatic dicarboxylic acids and/or ester-forming derivatives or mixtures thereof, and/or based on at least one aromatic dicarboxylic acid and/or the ester-forming derivatives or mixtures thereof.

5. A polymer blend according to claim 1, further comprising a partially aromatic copolyester, based on at least one C₂-C₁₂-alkanediol and/or at least one C₅-C₁₀-cycloalkanediol or mixtures thereof, or hydroxy compounds that contain ether functions.

6. A polymer blend according to claim 1, further comprising at least one copolyester, obtainable through polycondensation of at least one diol, for example from the series 2,1-ethanediol, 1,3-propane-diol, 1,4-butanediol and/or 1,6-hexanediol with at least one aromatic dicarboxylic acid, as for example, terephthalic acid and possibly at least one aliphatic dicarboxylic acid, such as adipic acid and/or sebacic acid.

7. A polymer blend according to claim 1, further comprising at least one polylactide, as well as polyhydroxybutyric acid and/or polyhydroxybutyric acid/valerianic acid copolyester and/or derivatives thereof.

8. A polymer blend according to claim 1, further comprising native starch, as for example, corn or potato starch, which is to the largest extent in crystalline form.

9. A polymer blend according to claim 1, further comprising structureless or thermoplastic starch.

10. A polymer blend according to claim 1, comprising:
1-20% of structureless or thermoplastic starch,
10-20% of a polylactide,
40-80% of an aliphatic/aromatic polyester, as well as
0-1% of a flow adjuvant

11. A process for the production of a polymer blend comprising:
mixing in a melt in an extruder at a temperature range of 120-250° C. at least one partially aromatic polyester and at least one aliphatic polyester, based, among other things, on at least one hydroxy-carboxylic acid and/or at least one lactone; and
extruding the mixture from the extruder.

12. A process as recited in claim 11, wherein the extruder is a two-shaft extruder.

13. A process, according to claim 11, wherein 10-25% of native starch with a natural water content of approximately 15-20% are mixed in the extruder with 10-25% of a polylactic acid, 60-80% of an aliphatic/aromatic polyester, 0-1% of a flow adjuvant, as well as possibly additional components and additives, and wherein the melt is at least almost completely degassed and extruded, and the granulate obtained has a residual moisture of 0.1-1%.

14. A process according to claim 11, wherein slipping agents,
inorganic fillers, such as, for example, talcum or kaolin or other additives, such as, for example, pigments, titanium dioxide, and substances of that kind are admixed to the extruder.

15. The use of the polymer blend according to claim 1, for the production of food films, particularly for the packaging of foodstuffs and/or fast-food products.

16. The use of the polymer blend according to claim 1, for the production of packaging materials for liquid, viscous or semi-liquid substances, in particular liquid foodstuffs, such as beverages, cooking oil, and substances of that kind.

17. The use of the polymer blend, according to claim 10, for the production of packing materials or moldings in connection with electrical or electronic applications.

18. The use of polymer blend according to claim 1, for the production of packing films for the non-food sector.

19. Beverage packaging with a multi-layer container wall comprising: at least one wall layer, made of reinforced paper, cardboard or similar material, and of at least one layer, such as preferably the inner layer, made of a polymer blend, according to one of claim 1.
